(19) United States
(12) Patent Application Publication
(10) Pub. No.: US 2004/0166042 A1
(43) Pub. Date: Aug. 26, 2004

(54) Method and apparatus for producing nitrogen gas

(75) Inventor: Hiroshi Fukuhara, Kanagawa (JP)

Correspondence Address: MCGINN & GIBB, PLLC, 8321 OLD COURTHOUSE ROAD, SUITE 200, VIENNA, VA, 22182-3817, US

(73) Assignee: Fukuhara Co., Ltd., Yokohama-shi (JP)

(21) Appl. No.: 10/718,641

(22) Filed: Nov. 24, 2003

(30) Foreign Application Priority Data
Nov. 26, 2002 (JP) P2002-382650
Dec. 17, 2002 (JP) P2002-383290

(51) Int. Cl. B01D 53/46; B01J 8/02

(52) U.S. Cl. 423/219; 422/211; 422/188; 422/190; 422/198

(57) ABSTRACT

A compressor generates compressed air. Iron powder is provided in a deoxidizing chamber. The compressed air is supplied to the deoxidizing chamber such that the compressed air reacts with the iron powder to form iron oxide, so that oxygen contained in the compressed air is reduced to obtain remained nitrogen gas.

### BACKGROUND OF THE INVENTION

The present invention generally relates to techniques concerning a method and apparatus for producing nitrogen gas and more particularly, to techniques for easily producing high-purity nitrogen gas at low cost.

Hitherto, there have been three kinds of common techniques concerning a method and apparatus for producing nitrogen gas, that is, a PSA (Pressure Swing Adsorption) technique, a membrane separation technique, and a cryogenic separation technique.

The PSA method is to pass compressed air through absorbent and then cause the absorbent to adsorb oxygen and so on from the compressed air by utilizing the properties of the adsorbent, which adsorbs specific gas under high pressure and desorbs the specific gas under low pressure, to thereby separate nitrogen. In this case, the PSA method has a principle similar to that of a heatless dryer. An apparatus for implementing this method is of the two column type that is larger than an apparatus for implementing the membrane separation technique (described later). A load for maintaining an electromagnetic valve and so on is imposed on the apparatus. Incidentally, the purity of nitrogen usually ranges from about 99% to about 99.9999%.

The membrane separation method is to separate nitrogen by supplying compressed air into a hollow fiber membrane, which is a hollow fiber-shaped polymer membrane, and utilizing the differences among amounts of gas components contained in the compresses air, which are transmitted by the membrane. In this case, an apparatus for implementing the membrane separation method is smaller than that for implementing the PSA method. Moreover, the maintenance load is small. However, the purity of nitrogen ranges from about 95% to about 99.9%. Therefore, the membrane separation method is not suited to needs for high-purity nitrogen gas.

The cryogenic separation method is directed to needs for mass-production of high purity nitrogen. This method is to separate and produce nitrogen by cooling air. For example, when the air is cooled to about −190° C., oxygen can be liquefied and separated, because the boiling point of nitrogen is −195.8° C. and that of oxygen is −183.0° C. In this case, high purity nitrogen, whose purity is equal to or higher than 99.999%, can be obtained. However, the cryogenic separation method requires large scale facility. On the other hand, in addition to a method of carrying nitrogen by a tank truck, a method of constructing a plant on the site of a factory of a major user or on an adjoining site thereof and then pipe the produced nitrogen thereto is employed as a method of supplying the produced nitrogen.

### SUMMARY OF THE INVENTION

In order to solve the above problems, according to the invention, there is provided a method of producing nitrogen gas, comprising steps of:

compressing air to generate compressed air;

providing iron powder; and

reacting the compressed air with the iron powder to form iron oxide, so that oxygen contained in the compressed air is reduced to obtain remained nitrogen gas.

Preferably, the producing method further comprises a step of adding a catalyst to the iron powder. Here, it is preferable that the catalyst is comprised of sodium chloride.

Preferably, the producing method further comprises a step of adding water to the iron powder. Here, it is preferable that the producing method further comprises a step of adding a moisture retaining material to the iron powder.

Preferably, the producing method further comprises a step of passing the compressed air through a hollow fiber membrane, before the compressed air is reacted with the iron powder.

Here, it is preferable that the producing method further comprises a step of heating the compressed air, before the compressed air is passed through the hollow fiber membrane.

It is also preferable that the hollow fiber membrane is comprised of polyimide.

Preferably, the producing method further comprises a step of passing the compressed air through a nitrogen generator according to a pressure swing absorption technique, before the compressed air is passed through the hollow fiber membrane.

According to the invention, there is also provided an apparatus for producing nitrogen gas, comprising:

a compressor, which generates compressed air; and

a deoxidizing chamber, in which iron powder is provided and to which the compressed air is supplied such that the compressed air reacts with the iron powder to form iron oxide, so that oxygen contained in the compressed air is reduced to obtain remained nitrogen gas.

Preferably, a catalyst is added to the iron powder. Here, it is preferable that the catalyst is comprised of sodium chloride.

Preferably, water is added to the iron powder. Here, it is preferable that a moisture retaining material is added to the iron powder.

Preferably, the producing apparatus further comprises a hollow fiber membrane, through which the compressed air is passed before being supplied to the deoxidizing chamber.

Here, it is preferable that the hollow fiber membrane is comprised of polyimide.

It is also preferable that the producing apparatus further comprises a throttle valve, arranged at an immediate downstream of the hollow chamber membrane and operable to adjust a flow rate of the compressed chamber passing through the hollow chamber membrane.

It is also preferable that the producing apparatus further comprises a heat exchanger, which heats the compressed air before the compressed air passes through the hollow chamber membrane.

Preferably, the producing apparatus further comprises a nitrogen generator according to a pressure swing absorption technique, through which the compressed air is passed before being supplied to the deoxidizing chamber.

Here, it is preferable that the nitrogen gas generator comprises: a first oxygen absorbing tank; a first throttle valve, operable to adjust a flow rate of the compressed air passing through the first oxygen absorbing tank; a second oxygen absorbing tank; and a second throttle valve, operable to adjust a flow rate of the compressed air passing through the second oxygen absorbing tank.

Preferably, the producing apparatus further comprises a filter, which removes dusts from the nitrogen gas supplied from the deoxidizing chamber.

According to the above configurations, nitrogen gas with high purity can be easily obtained with lower cost.

According to the provision of the divided pipeline, two kinds of nitrogen gas having different purities can be easily obtained with lower cost.

According to the provision of the heat exchanger, nitrogen gas with high purity can be stably obtained independent of seasons.

According to the provision of the filter at the downstream of the deoxidizing chamber, the obtained nitrogen gas is used in another equipment with safety.

In a case where the nitrogen gas generator according to the PAS technique is used, high-purity nitrogen gas can be obtained without deviation from the desired value.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a schematic diagram of an apparatus for producing nitrogen gas according to a first embodiment of the invention;

FIG. 2 is a graph showing a relationship between an air supply time period and an oxygen concentration measured by an oxygen analyzer provided in an apparatus for producing nitrogen gas according to a second embodiment of the invention;

FIG. 3 is a schematic diagram of an apparatus for producing nitrogen gas according to a third embodiment of the invention;

FIG. 4 is a schematic diagram of an apparatus for producing nitrogen gas according to a fourth embodiment of the invention; and

FIG. 5 is a schematic diagram of an apparatus for producing nitrogen gas according to a fifth embodiment of the invention.

### DETAILED DESCRIPTION OF THE INVENTION

Preferred embodiments of the invention will be described in detail hereinbelow by referring to the accompanying drawings.

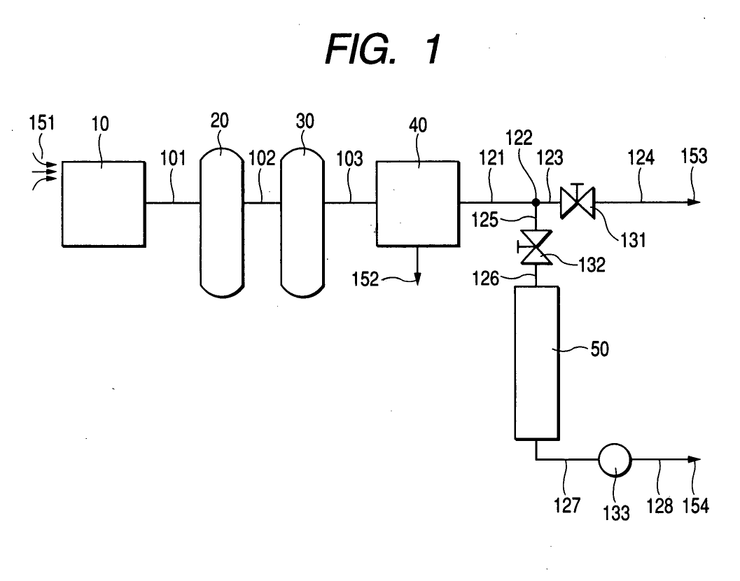

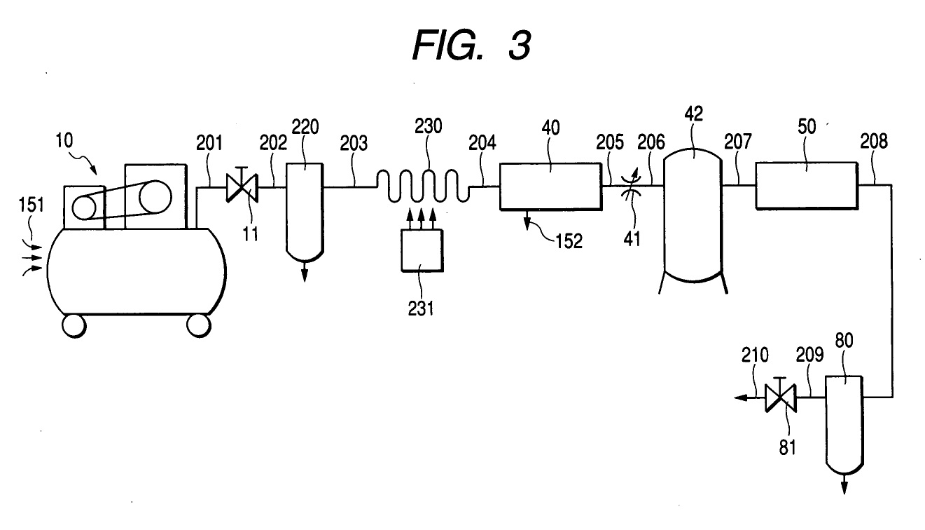

As shown in FIG. 1, reference numeral 10 designates a compressor. Although not concretely shown in this figure (see FIGS. 3 to 5), the compressor consists of an electric motor and a compressor body. A rotation of the electric motor is transmitted to the compressor body through a belt. Compressed air is produced by sucking air 151. Then, the compressed air is stored in an air tank (not concretely shown).

Here, the air tank may be disposed at a middle portion or a downstream portion of each of pipelines 101, 102, and 103, instead of being formed in such a way as to be integral with the compressor 10.

The compressed air stored in the air tank is fed into a hollow fiber membrane 40 through the pipeline 101, a pre-filter 20 for eliminating foreign matters in the compressed air, the pipeline 102, a micromist filter 102 for eliminating micro foreign matters, and the pipeline 103.

A dryer for drying the compressed air may be disposed between the compressor 10 and the filter 20.

In a case where the pre-filter has capability to eliminate large foreign matters, which are contained in the compressed air and have a size equal to or larger than 3 μm, it is preferable that the micromist filter 30 has capability to eliminate micro foreign matters that are present in the compressed air and have a size being equal to or larger than 0.01 μm. In some cases, an activated carbon filter having capability to remove odor in the compresses air may be provided downstream of the micromist filter 30. Incidentally, the capabilities of the filters 20 and 30 are not limited to the aforementioned capabilities.

The hollow fiber membrane 40 is formed from a bundle of straw-shaped polyester hollow fibers. The compressed air is passed through the inside of each of the hollow fibers. Then, the apparatus utilizes the difference among the inherent permeation rates of various kinds of gases, which are contained in the air, through the hollow fiber membrane thereby to allow nitrogen gas, which is a maximum component of the air, to remain therein.

The permeation rates of the component gases of the compressed air vary from those of gases, which easily permeate therethrough, to those of gases, which are hard to permeate therethrough. Finally, a nitrogen gas remains. Especially, in the case that the hollow fiber membrane is made from polyester, moisture vapors are most permeable. The second most permeable gases are a hydrogen gas and a helium gas. The third most permeable gases are a carbon dioxide gas and a carbon monoxide gas. Finally, an oxygen gas, an argon gas, and a nitrogen gas are least permeable. Among these gases, a nitrogen gas is the least permeable. Thus, the nitrogen gas remains.

Therefore, when compressed air containing about 80% of nitrogen and about 20% of oxygen is fed into the inside of the hollow fiber membrane 40, oxygen having a permeation rate being higher than. that of nitrogen goes out from the inside of the hollow fiber membrane 40 to the outside in preference. Thus, the closer to the outlet, the lower the concentration of oxygen in the air flowing in the inside of the hollow fiber membrane 40. Consequently, high-concentration nitrogen gas is obtained.

In a case where temperature does not change, the purity of the produced nitrogen gas depends upon both the pressure of the compressed air and time, that is, depends upon the flow rate thereof.

A polyolefin resin and a polypropylene resin may be employed as the material of a hollow fiber membrane, in addition to polyester.

The nitrogen gas, which remains as a result of passing the compressed air through the hollow fiber membrane 40, reaches a branch portion 122 through a pipeline 121.

Two piping systems are configured in such a way as to extend from the branch portion 122. One of the piping systems consists of first branch pipelines 123, 124 and a valve 131.

Furthermore, the other piping system consists of second branch pipelines 125, 126, 127, 128, a valve 132 and a deoxidizing chamber 50.

The valves 131 and 132 are provided in such a way as to be able to select one of the two piping systems by opening or closing the valves 131 and 132.

The deoxidizing chamber 50 is provided at an end of the second branch pipeline 126, with the intention of eliminating a small amount of oxygen contained in the nitrogen gas, which remains as a result of passing the compressed air through the hollow fiber membrane 40. In this embodiment, iron powder, sodium chloride serving as catalyst for promoting oxidation of iron, and a small amount of water are provided in the deoxidizing chamber 50.

The deoxidizing chamber 50 may be adapted to various cases, for example, cases that only the iron powder is provided therein, that the iron powder and the catalyst are provided therein, and that the iron powder and the water are provided therein. Here, other materials, such as potassium chloride or calcium chloride, may be employed as the catalyst, in addition to or instead of the sodium chloride. Further, activated carbon or a moisture retention material such as vermiculite may be added.

As a preferable example is obtained by adding about 50 cc of water to 1 kg. of a mixture containing 78 wt % of iron powder, 8 wt % of sodium chloride, 10 wt % of activated carbon and 4 wt % of a moisture retention material.

On the other hand, the reactions among these materials generate heat, so that the moisture evaporates. Thus, to supply water so as to compensate for loss of moisture, which is caused by being evaporated by the generated heat, a water pot may be connected to the deoxidizing chamber 50 through a water supply pipe, a manually operable valve, and a water supply pipe.

Although the apparatus illustrated in FIG. 3 has only one deoxidizing chamber 50, two deoxidizing chambers may be provided in parallel. In such a configuration, in a case where iron powder filled in one of the deoxidizing chambers is deteriorated, the other deoxidizing chamber is used during the replacement of the filler in the one of the deoxidizing chamber. Therefore, when one of the deoxidizing chambers is used, there is need for closing the valves, which are provided at an inlet and an outlet of the other absorber, so as to prevent the nitrogen gas from flowing into the other deoxidizing chamber. Even when the other deoxidizing chamber is used, it is necessary that the one of the absorbers has a similar configuration.

Next, an operation of the apparatus according to the embodiment will be described.

First, compressed air is produced by activating the compressor 10 to thereby take in air 151. Incidentally, the compressed air is fed into the hollow fiber membrane 40 through the pipeline 101, the pre-filter 20, the pipeline 102 and the micromist filter 30, the pipeline 103. Therefore, foreign matters, which deteriorate the hollow fiber membrane 40, are eliminated by the pre-filter 20 and the micromist filter 30.

The hollow fiber membrane 40 eliminates mainly oxygen contained in the compressed air and additionally moisture vapor, hydrogen, helium, a carbon dioxide gas, a carbon monoxide gas, and an argon gas. Thus, nitrogen gases are made to remain in the hollow fiber membrane 40. Thereafter, the nitrogen gas is discharged and fed to the pipeline 121. The purity of this nitrogen gas is about 95% through about 99.9%. Therefore, this nitrogen gas slightly contains oxygen.

In this case, the nitrogen gas discharged from the hollow fiber membrane 40 reaches the branch portion 122 through the pipeline 121.

Therefore, when the valve 131 is opened and the valve 132 is closed, the nitrogen gas discharged from the hollow fiber membrane 40 can be used as the nitrogen gas 153 fed from the first branch pipeline 124. Incidentally, the purity of the nitrogen gas 153 discharged in this case is about 95% to about 99.9%.

On the other hand, when the valve 131 is closed and the valve 133 is opened, the nitrogen gas discharged from the hollow fiber membrane 40 is fed into the deoxidizing chamber 50 through the second branch pipeline 126. Incidentally, the nitrogen gas fed thereinto slightly contains oxygen and reacts with the iron of the deoxidizing chamber 50 to thereby produce iron oxide. Consequently, the oxygen is reduced, so that the purity of the nitrogen gas is enhanced.

When water is slightly contained in the iron, the oxidization of the iron is promoted. When the catalyst, such as sodium chloride, is added thereto, the oxidization of the iron is also promoted. Naturally, when both the water and the catalyst are added thereto, the oxidization of the iron is further promoted.

Thus, the purity of the nitrogen gas discharged from the hollow fiber membrane 40 and fed into the deoxidizing chamber 50 is enhanced. The nitrogen gas is fed through the second branch pipeline 127, the oxygen analyzer 133, and the second branch pipeline 128, and can be used as the high-purity nitrogen gas 154. In this case, the purity of the high purity nitrogen gas 154 can be enhanced to about 99% through about 99.99%.

The oxygen analyzer 133 is provided so as to check the purity of the nitrogen gas. Since the oxidizing ability of the deoxidizing chamber deteriorates with time, the oxygen analyzer 133 is provided so as to determine when each of the iron, the water, and the catalyst provided in the deoxidizing chamber should be replaced.

As a second embodiment of the invention, the pipeline 101 of FIG. 1 may be directly connected to the deoxidizing chamber 50. That is, this embodiment includes the compressor 10, the pipeline 101, the deoxidizing chamber 50, the second branch pipeline 127, the oxygen analyzer 133, and the second branch pipeline 128. With this configuration, a nitrogen gas having a certain purity can be obtained by merely using the deoxidizing chamber 50.

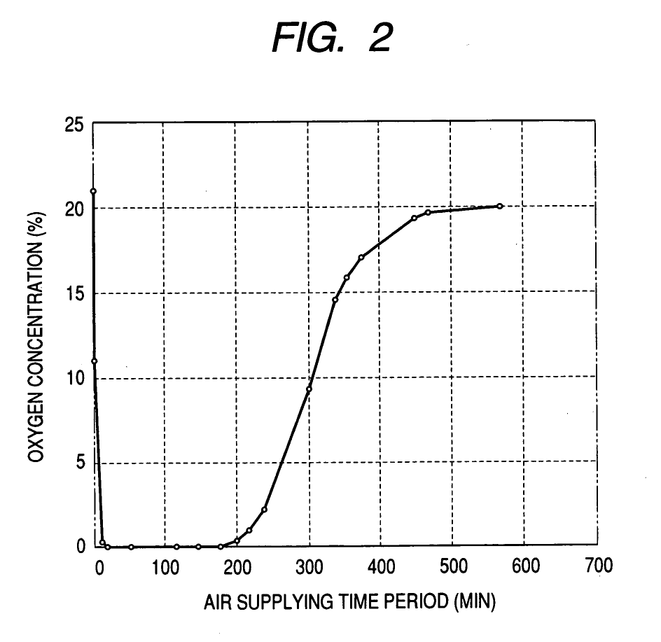

That is, as is seen from FIG. 2, a nitrogen gas having a certain purity can be obtained by merely using the deoxidizing chamber 50 until about 180 minutes elapses.

A third embodiment of the invention will be described with reference to FIG. 3. The elements similar to those in the first embodiment are designated by the same reference numerals, and the repetitive explanation for those will be omitted.

The entire apparatus is configured by the following elements and enabled to produce high-purity nitrogen gas from the compressed air stored in the tank by the air compressor 10. Specifically, the apparatus comprises a pipeline 201, a manually operable valve 11, a pipeline 202, an air filter 220 for eliminating dust and oil mist from the compressed air, a pipeline 203, a first heat exchanger 230 for heating the compressed air, a pipeline 204, a hollow fiber membrane (nitrogen gas generator) 40 for removing oxygen from the compressed air, a pipeline 205, a throttle valve 41 for adjusting the flow rate of the compressed air flowing through the hollow fiber membrane 40, a pipeline 206, a nitrogen gas tank 42 for storing nitrogen gas, a pipeline 207, a deoxidizing chamber 50 for further removing oxygen from the nitrogen gas, a pipeline 208, an air filter 80 for removing dust generated in the deoxidizing chamber 50, a pipeline 209, a manually operable valve 81, and a pipeline 210.

Although the apparatus of this embodiment has only one. air filter 220 so as to eliminate dust and oil mist, the apparatus may have a plurality of filters respectively corresponding to purposes as in the first embodiment. That is, a pre-filter for removing dust from the compressed air, and a mist filter and a micromist filter, which are used for removing oil from the compressed air.

In such a case, various modifications of the configuration of the air filter may be made. In the case of constituting the air filter by three filters, that is, a pre-filter, a mist filter, and a micromist filter, which are arranged in this order from an upstream side, for example, the sizes of minimum foreign matters, which can be trapped by the pre-filter, the mist filter, and the micromist filter, respectively, may be 3 μm, 0.1 μm, and 0.01 μm. Alternatively, the sizes of such minimum foreign matters may be 5 μm, 0.5 μm, and 0.01 μm, respectively. Eventually, the sizes of minimum foreign matters, which can be trapped by the pre-filter, the mist filter, and the micromist filter, have a value ranging from 1 μm to 5 μm, a value ranging from 0.05 μm to 0.5 μm, and a value of 0.01 μm, respectively.

A structure, in which a filter element for trapping foreign matters is accommodated in each of all filter bodies, may be employed as an example of the structure of the air filter 220 or each of the filters of the air filter 220. Furthermore, condensed and accumulated drain water can be discharged from the air filter 220 or each of the filters in the air filter 220. Incidentally, regarding the structure described herein, it is the same with an air filter 80 (to be described later).

Additionally, the number of filters constituting the air filter 220 is limited to neither one nor three. The number of such filters may be either two or four or more, as long as the filters are arranged so that the more downstream the location of the filter, the higher the ability to trap foreign matters.

The first heat exchanger 230 is constituted by a meandering pipe. Heating by sending warm air from a heater 231 is employed in this embodiment. However, various other heating methods may be employed. For example, steam or warm water is passed through the outside surface of the meandering pipe. Alternatively, Nichrome wires are provided on the outside surface of the meandering pipe and then energized thereby to heat the meandering pipe by heat generated by energizing the Nichrome wires.

The throttle valve 41 is provided just downstream from the hollow fiber membrane 40 in such a way as to be able to change the flow rate of the compressed air.

Although FIG. 3 shows a configuration provided with one hollow fiber membrane 40 and one throttle valve 41, an (m×n) configuration in which “n” of sets, each of which is constructed by serially connecting “m” of hollow fiber membranes and one throttle valve, are connected in parallel. In this case, the flow rate of compressed air flowing through “m” of hollow fiber membranes can be changed by the single throttle valve.

Each of the values of “m” and “n” may be 1, 2, or more. Naturally, the values of m and n may be different from each other. Such an (m x n) configuration may be incorporated between the pipeline 204 (junction) and the pipeline 206 (juncture).

Although a configuration in which mere the hollow fiber membrane 40 and the throttle valve 41 are provided ensures nitrogen gas whose purity is concretely 98% to 99.5%, nitrogen gas, whose purity is about 99.9%,. can be stationarily ensured regardless of seasons, such as summer and winter, by heating the compressed air through the first heat exchanger 230 as in this embodiment.

The position of the nitrogen gas tank 42, which is provided between the throttle valve 41 and the deoxidizing chamber 50 shown in FIG. 3, for storing nitrogen gas is not limited thereto. The nitrogen gas tank 42 may be located between the deoxidizing chamber 50 and the air filter 80 (to be described later) or between the air filter 80 and the valve 81.

The air filter 80 is provided so as to remove dust adhering to the gaseous substances in the deoxidizing chamber 50.

Electromagnetic valves or electrically operable valves may be used as the valves 11 and 81, instead of the manually operable valves 11 and 81.

Next, an operation of apparatus according to this embodiment will be described in detail.

First, when the motor of the air compressor 10 is activated, the rotation of the motor is transmitted to the compressor (body) by a belt, so that compressed air is stored in the tank.

Then, the compressed air stored therein is fed into the nitrogen gas tank 42 through the pipeline 201, the valve 11, the pipeline 202, the air filter 220, the pipeline 203, the first heat exchanger 230, the pipeline 204, the hollow fiber membrane 40, the pipeline 205, the throttle valve 41, and the pipeline 206.

In this case, various foreign matters, such as oil and dust, are eliminated from the air filter 220 by opening the valve 11. Thereafter, clean compressed air is fed into the first heat exchanger 230.

In the first heat exchanger 230, the compressed air is heated. by the warm air heater 31. Further, a heating temperature may be set to a value that is higher than an ambient temperature by 10° C. or 15° C. Alternatively, the heating temperature may be set to be always 40° C. or 50° C.

It is expected that the flow rate of high purity nitrogen gas in the hollow fiber membrane 40 is increased by feeding the high temperature compressed air into the hollow fiber membrane 40. That is, when the flow rate of nitrogen gas is constant, higher purity nitrogen gas is obtained by heating the compressed air. When the purity of the nitrogen gas is made to be constant, the flow rate of the nitrogen gas is increased.

TABLE 1

| | | | |
|---|---|---|---|
| flow rate ratio of produced nitrogen gas | 0.9 | 1.0 | 1.1 |
| temperature of compressed air (° C.) | 10 | 25 | 40 |

Table 1 shows a relationship between the flow rate ration of the generated nitrogen gas and the compressed air temperature, under a condition that the pressure of the supplied compressed air is set to be 7 kg/cm²G to produce nitrogen gas having a purity of 99%.

As shown in the table, the flow rate of nitrogen gas increases when the temperature of the compressed air is raised.

Thus, the provision of the first heat exchanger 230, the hollow fiber membrane 40, and the throttle valve 41 ensures, regardless of seasons, such as summer and winter, that the purity of the produced nitrogen gas about. 99.9%. Such. nitrogen gas is fed into the nitrogen gas tank 42 through the pipeline 206. Then, the nitrogen gas is stored in the nitrogen gas tank 42.

Subsequently, the nitrogen gas stored in the nitrogen gas tank 42 is fed to the deoxidizing chamber 50 through the pipeline 207.

Finally, opening the valve 81, the nitrogen gas having a purity of 99.99%, in which the purity is enhanced by the deoxidizing chamber 50, can be supplied from the pipeline 210 by completely removing dust adhered in the deoxidizing chamber 50 through the air filter 80.

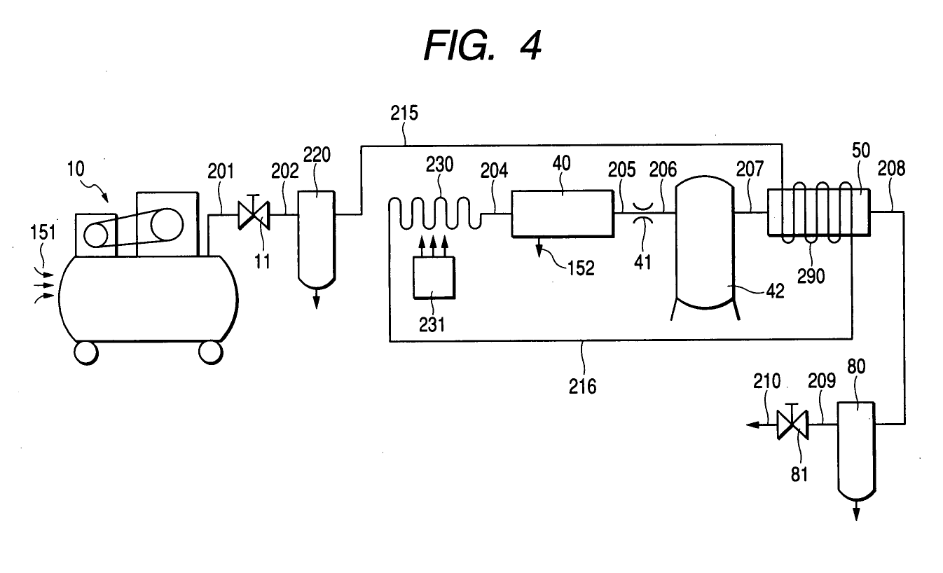

FIG. 4 shows a fourth embodiment of the invention. This embodiment differs from the third embodiment in that a pipeline 215, a second heat exchanger 290, and a pipeline 216 are provided instead of the pipeline 203 of the third embodiment.

In this embodiment, the second heat exchanger 290 is provided so as to utilize heat generated in the deoxidizing chamber 50. Therefore, according to the condition in which heat is generated in the deoxidizing chamber 50, the first heat exchanger 230 may be omitted. Moreover, the positions of the first heat exchanger 230 and the second heat exchanger 90 may be inversed from the standpoint of the compressed air flow.

The description of an operation of the fourth embodiment is omitted herein, because the difference in operation between the third embodiment and the fourth embodiment is only that heat generated in the second heat exchanger 290 is added to the heat generated in the first heat exchanger 230 of the first embodiment.

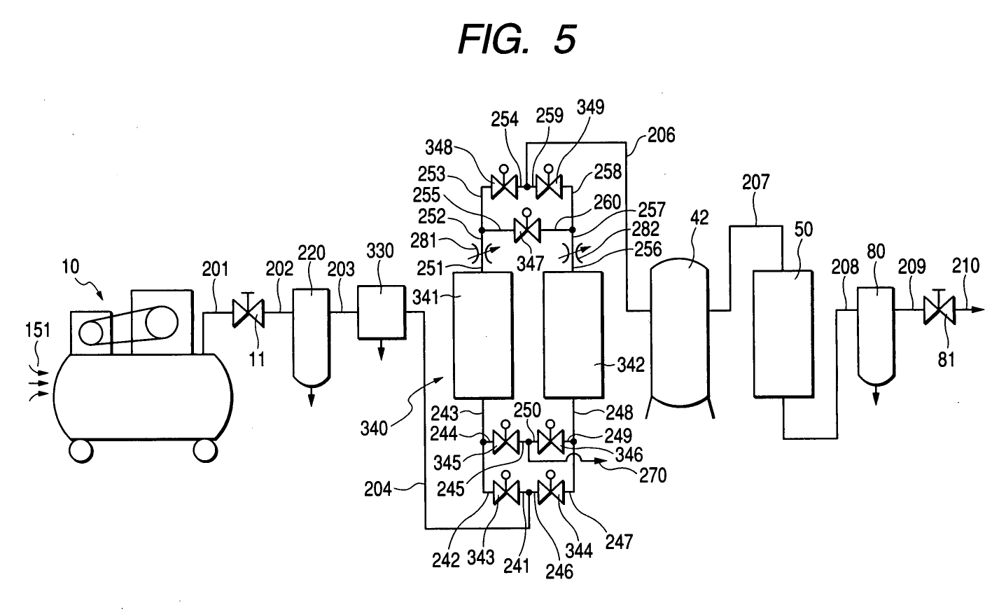

FIG. 5 shows a fifth embodiment of the invention. The elements similar to those in the third embodiment are designated by the same reference numerals, and the repetitive explanation for those will be omitted. The difference between these embodiments are that an air dryer 330 for drying the compressed air and a PAS-type nitrogen gas generator 340 are provided instead of the first heat exchanger 230, the hollow fiber membrane 40 and the throttle valve 41 in the third embodiment.

As the dryer 330, a refrigeration dryer, a membrane dryer, a desiccant dryer, and other dryers may be used, as long as the dryers have the function of drying compressed air. Further, the dryer 330 is adapted so that condensed and accumulated drain water can be discharged therefrom.

Next, the PSA nitrogen gas generator 340 includes a first adsorption tank 341 and a second adsorption tank 342. Additionally, the PSA nitrogen gas generator 340 includes electromagnetic valves 343, 344, 345, 346, 347, 348, and 349, a first throttle valve 281, a second throttle valve 282, and internal pipelines 241, 242, 243, 244, 245, 246, 247, 248, 249, 250, 251, 252, 253, 254, 255, 256, 257, 258, 259, and 260.

More particularly, the internal pipelines 241 and 246 are connected to and branch off the pipeline 204. Further, the internal pipelines 254 and 259 are integrally formed and connected to the pipeline 206.

Among the pipes, the internal pipeline 241 is connected to the electromagnetic valve 343, the internal pipeline 242, the internal pipeline 243, the first adsorption tank 341, the internal pipeline 251, the first throttle valve 281, the internal pipeline 252, the internal pipeline 253, the electromagnetic valve 348, and the internal pipeline 254 in this order.

Further, the internal pipeline 246 is connected to the electromagnetic valve 344, the internal pipeline 247, the internal pipeline 248, the second adsorption tank 342, the internal pipeline 256, the second throttle valve 282, the internal pipeline 257, the internal pipeline 258, the electromagnetic valve 349, and the internal pipeline 259 in this order.

Furthermore, the internal pipeline 244 is connected to the connection portion between the internal pipelines 242 and 243. The internal pipeline 249 is connected to the connection portion between the internal pipelines 247 and 248. The internal pipeline 244 is connected to the electromagnetic valve 345, the internal pipeline 245, the internal pipeline 250, the electromagnetic valve 346, and the internal pipeline 249 in this order. An exhaust pipe 270 is connected to the connection portion between the internal pipelines 245 and 250.

On the other hand, the internal pipeline 255 is connected to the connection portion between the internal pipelines 252 and 253. The internal pipeline 260 is connected to the connection portion between the internal pipelines 257 and 258. The internal pipeline 255 is connected to the electromagnetic valve 47 and the internal pipeline 260 in this order.

Each of the first and second adsorption tanks 341 and 342 accommodates a kind of activated carbon that has large oxygen adsorption capacity, that provides a large difference in adsorption rate between oxygen and nitrogen, that can remove nitrogen gas from the air by preferentially adsorbing oxygen in a short time under pressure, and that can easily desorb the adsorbed oxygen by resetting the pressure to a normal pressure.

Next, an operation of the apparatus of this embodiment will be described in detail.

First, when the motor of the air compressor 10 is activated, the rotation of the motor is transmitted to the compressor (body) by a belt, so that compressed air is stored in the tank.

Various foreign matters, such as oil and dust, are eliminated from the air filter 220 by opening the valve 11. Thereafter, clean compressed air is fed into the dryer 330.

Subsequently, the dryer 330 supplies dried compressed air to the following PAS nitrogen gas generator 340.

The PAS nitrogen gas generator 340 separates and extracts nitrogen gas from the compressed air by constituting the first and second adsorption tanks 341 and 342 each accommodating a kind of activated carbon that has large oxygen adsorption capacity and that provides a large difference in adsorption rate between oxygen and nitrogen, and by utilizing the properties of the adsorption material that adsorbs oxygen gas under high pressure and that desorbs oxygen gas under low pressure.

Thus, the first and second adsorption tanks 341 and 342 each accommodating adsorbent separate and extract high-purity nitrogen gas from the compressed air and then supplies the extracted nitrogen gas by alternately and iteratively performing a compressing operation (that is, a pressure increasing operation) and a decompressing operation (that is, a pressure decreasing operation) through the actions of the electromagnetic valves 343, 344, 345, 346, 347, 348, and 349.

In this case, the first adsorption tank 341 pressurizes by supplying the compressed air, while the second adsorption tank 342 depressurizes to a normal pressure. The adsorbent of the first adsorption tank 341 feeds high purity nitrogen gas to the pipeline 206 according to the properties that this adsorbent adsorbs a large amount of oxygen at an initial stage of the adsorption, and that an adsorption amount is large under high pressure. The adsorbent of the second adsorption tank 342 discharges mainly oxygen from the exhaust pipe 270 by separating and desorbing the absorbed oxygen.

To alternately performing the pressurizing operation and the depressurizing operation, it is necessary to open and close the electromagnetic valves 343, 344, 345, 346, 347, 348, and 349 disposed at middle portions of the internal pipelines 241, 242, 243, 244, 245, 246, 247, 248, 249, 250, 251, 252, 253, 254, 255, 256, 257, 258, 259, and 260. This is a known technique. Therefore, the detailed description thereof is omitted.

Further, the first and second throttle valves 281 and 282 are provided immediately downstream from the first and second adsorption tanks 341 and 342, respectively, so as to change and adjust the flow rates of the compressed air flowing through the first and second adsorption tanks 341 and 342. Thus, the difference and variation of the purity of the nitrogen gas due to seasonal factors and slight differences between the adsorption tanks 341 and 342 in pipe resistance, length, and size, are regulated in such a way as to increase the purity of nitrogen gas and decrease the variation thereof, and as to thus obtain high purity nitrogen gas.

Incidentally, it is not always necessary that the first and second throttle valves 281 and 282 are located downstream from the first and second adsorption tanks 341 and 342, respectively. The first and second throttle valves 281 and 282 may be located upstream from the first and second adsorption tanks 341 and 342, respectively.

Thus, the nitrogen gas ensured to have a high purity of about 99.9% is fed into the nitrogen gas tank 42 through the pipeline 206 and then stored therein.

Further, the nitrogen gas stored in the nitrogen gas tank 42 is supplied to the deoxidizing chamber 50 through the pipeline 207.

In the deoxidizing chamber 50, oxygen is removed from the nitrogen gas, which is mixed with oxygen, by oxidizing the iron powder filled therein and simultaneously generating heat. Thus, the purity of the nitrogen gas is further enhanced.

Finally, opening the valve 81, the nitrogen gas having a purity of 99.99% with little deviation, which is obtained by the deoxidizing chamber 50, is supplied from the pipeline 210 through the air filter 80.

Although the present invention has been shown and described with reference to specific preferred embodiments, various changes, modifications and combinations will be apparent to those skilled in the art from the teachings herein. Such changes and modifications as are obvious are deemed to come within the spirit, scope and contemplation of the invention as defined in the appended claims.

What is claimed is:

1. A method of producing nitrogen gas, comprising steps of:
compressing air to generate compressed air;
providing iron powder; and
reacting the compressed air with the iron powder to form iron oxide, so that oxygen contained in the compressed air is reduced to obtain remained nitrogen gas.

2. The producing method as set forth in claim 1, further comprising a step of adding a catalyst to the iron powder.

3. The producing method as set forth in claim 2, wherein the catalyst is comprised of sodium chloride.

4. The producing method as set forth in claim 1, further comprising a step of adding water to the iron powder.

5. The producing method as set forth in claim 4, further comprising a step of adding a moisture retaining material to the iron powder.

6. The producing method as set forth in claim 1, further comprising a step of passing the compressed air through a hollow fiber membrane, before the compressed air is reacted with the iron powder.

7. The producing method as set forth in claim 6, further comprising a step of heating the compressed air, before the compressed air is passed through the hollow fiber membrane.

8. The producing method as set forth in claim 6, wherein the hollow fiber membrane is comprised of polyimide.

9. The producing method as set forth in claim 1, further comprising a step of passing the compressed air through a nitrogen generator according to a pressure swing absorption technique, before the compressed air is passed through the hollow fiber membrane.

10. An apparatus for producing nitrogen gas, comprising:
a compressor, which generates compressed air; and
a deoxidizing chamber, in which iron powder is provided and to which the compressed air is supplied such that the compressed air reacts with the iron powder to form iron oxide, so that oxygen contained in the compressed air is reduced to obtain remained nitrogen gas.

11. The producing apparatus as set forth in claim 10, wherein a catalyst is added to the iron powder.

12. The producing apparatus as set forth in claim 11, wherein the catalyst is comprised of sodium chloride.

13. The producing apparatus as set forth in claim 10, wherein water is added to the iron powder.

14. The producing apparatus as set forth in claim 13, wherein a moisture retaining material is added to the iron powder.

15. The producing apparatus as set forth in claim 10, further comprising a hollow fiber membrane, through which the compressed air is passed before being supplied to the deoxidizing chamber.

16. The producing apparatus as set forth in claim 15, further comprising a heat exchanger, which heats the compressed air before the compressed air passes through the hollow. chamber membrane.

17. The producing apparatus as set forth in claim 15, wherein the hollow fiber membrane is comprised of polyimide.

18. The producing apparatus as set forth in claim 10, further comprising a nitrogen generator according to a pressure swing absorption technique, through which the compressed air is passed before being supplied to the deoxidizing chamber.

19. The producing apparatus as set forth in claim 15, further comprising a throttle valve, arranged at an immediate downstream of the hollow chamber membrane and operable to adjust a flow rate of the compressed chamber passing through the hollow chamber membrane.

20. The producing apparatus as set forth in claim 10, further comprising a filter, which removes dusts from the nitrogen gas supplied from the deoxidizing chamber.

21. The producing apparatus as set forth in claim 18, wherein the nitrogen gas generator comprises:
a first oxygen absorbing tank;
a first throttle valve, operable to adjust a flow rate of the compressed air passing through the first oxygen absorbing tank;
a second oxygen absorbing tank; and
a second throttle valve, operable to adjust a flow rate of the compressed air passing through the second oxygen absorbing tank.
